(19) United States
(12) Patent Application Publication
(10) Pub. No.: US 2007/0244816 A1
(43) Pub. Date: Oct. 18, 2007

(54) SYSTEMS AND METHODS FOR OPENING, FUNDING, AND/OR USING A FINANCIAL ACCOUNT, SUCH AS A CHECKING ACCOUNT

(76) Inventors: Mustafa Patni, Lake Forest Park, WA (US); Phillip J. Rogers, San Pablo, CA (US); Paul Willard, Seattle, WA (US); Matthew Macomber, Walnut Creek, CA (US); Richard Starbuck, Walnut Creek, CA (US)

Correspondence Address: PERKINS COIE LLP;PATENT-SEA, P.O. BOX 1247, SEATTLE, WA, 98111-1247, US

(21) Appl. No.: 11/735,310

(22) Filed: Apr. 13, 2007

Related U.S. Application Data
(60) Provisional application No. 60/792,179, filed on Apr. 14, 2006.

(51) Int. Cl. G06Q 40/00

(52) U.S. Cl. 705/45

(57) ABSTRACT

Systems and methods for opening, funding, and/or using a financial account are disclosed herein. In one embodiment, a computer-implemented method for providing a financial account includes receiving a request from a user to open a financial account. In response to receiving the request, the method further includes providing a plurality of unused checks to the user. The method additionally includes receiving a first check which has been used in commerce and includes a first signature of the user, and storing an image of the first signature from the first check. The method further includes receiving a second check which has been used in commerce and includes a second signature of the user, and comparing the second signature on the second check to the image of the first signature to authenticate the second signature.

### CROSS-REFERENCE TO APPLICATION(S) INCORPORATED BY REFERENCE

The present application claims priority to U.S. Provisional Patent Application No. 60/792,179, filed Apr. 14, 2006, entitled “SYSTEMS AND METHODS FOR OPENING, FUNDING, AND/OR USING A FINANCIAL ACCOUNT, SUCH AS A CHECKING ACCOUNT,” and incorporated herein in its entirety by reference. The present application incorporates the subject matter of U.S. Provisional Patent Application No. 60/717,389, entitled “SYSTEMS AND METHODS FOR OPENING, FUNDING, AND MANAGING FINANCIAL ACCOUNTS,” filed Sep. 15, 2005, in its entirety by reference.

### BACKGROUND

To open a new checking account, a person will typically walk into a bank or credit union of his or her choice and fill out the necessary paperwork. The paperwork will generally include some forms for providing personal information and other forms for providing information about the source of money used to fund the account. In addition, the person is typically required to provide a signature on, e.g., a signature card that is held by the bank of other financial institution as an example or “exemplar” of the person's signature for future reference if signature verification is needed. Once the personal information and the source of funds has been verified, the bank will typically send a box of blank checks to the new account holder so that he or she can begin using them in commerce.

Recently, banks and other financial institutions have developed new ways for people to open checking accounts and other types of financial accounts “on-line.” To open an account on-line, the person accesses a web site with a personal computer or other network device and electronically fills out part of a new account application. In addition, the person applying for the account will also have to print out one or more documents which he or she must then fill out, sign, and return to the bank before the account can be opened. As in the walk-in scenario described above, these paper documents can include personal identification information (e.g., social security number, mother's maiden name, etc.), source of funds information, and/or a signature card for recording an example signature of the new account holder. While existing methods for opening new accounts on-line may be more expedient than conventional walk-in methods, they still require the new account holder to fill out paper copies of various forms and send them into the bank before the account can be opened.

Computers have been networked to exchange data between them for decades. One important network, the Internet, comprises a vast number of computers and computer networks interconnected through communication channels. The Internet is used for a variety of reasons, including electronic commerce, exchanging information such as electronic mail, retrieving information and doing research, and the like. Many standards have been established for exchanging information over the Internet, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g. PDA's). All of these protocols provide easier ways to provide information to people via various data processing devices. Many other protocols and means for exchanging data between data processing device continue to develop to further aid the exchange of information.

### BRIEF DESCRIPTION OF THE DRAWINGS

FIG. 1 is a block diagram of a basic and suitable computer that may employ aspects of the invention.

FIG. 2A is a block diagram illustrating a simple, yet suitable system in which aspects of the invention may operate in a networked computer environment.

FIG. 2B is a block diagram illustrating an alternative system to that of FIG. 2A.

FIG. 3 is a flow diagram of a routine for opening a new account in accordance with an embodiment of the invention.

FIG. 4 illustrates a flow diagram of a routine for opening a new account in accordance with another embodiment of the invention.

FIG. 5 is a schematic diagram of a screen display for receiving user-information about a new account.

FIGS. 6A-6D illustrate a series of screen displays for gathering and/or verifying personal information associated with a new account applicant.

FIGS. 7A-7C illustrate a series of screen displays for selecting a source of funds and/or making an opening deposit in an account in accordance with an embodiment of the invention.

FIG. 8 illustrates a screen display for verifying the identity of a person wishing to open a new account.

FIG. 9 illustrates a screen display for selecting a user name and password.

FIGS. 10A and 10B illustrate a screen display which can be used to convey information about next steps and other aspects of a new account to a new account holder.

FIGS. 11A and 11B are screen displays illustrating two examples of informative electronic notifications that can be sent to new account holders after the account has been approved.

A portion of this disclosure contains material to which a claim for copyright is made. The copyright owner has no objection to the facsimile reproduction by anyone of the patent document or patent disclosure (including the Figures) as it appears in the Patent and Trademark Office patent file or records, but the copyright owner reserves all other copyright rights whatsoever.

The headings provided herein are for convenience and do not necessarily affect the scope or interpretation of the invention.

### DETAILED DESCRIPTION

Various embodiments of the present invention are directed to computer-implemented methods and systems for opening, funding, and/or using a checking account or other financial account. As described in greater detail below, in at least one embodiment of the present invention, a customer can open a new checking account on-line. In this embodiment, the customer is not required to send in a signed signature card or other signed or filled-out paperwork prior to using the account. Instead, the customer can take all the steps necessary to open the account on-line, and can begin writing checks as soon as his or her new checks arrive in the mail. Further, in this embodiment, one of the checks (e.g., the first check, or a “first check exemplar) that the new account holder uses can be imaged and stored in an appropriate database for future reference if needed for signature verification and/or authentication.

The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

A. Suitable Computing Environments in Which Aspects of the Invention can be Implemented

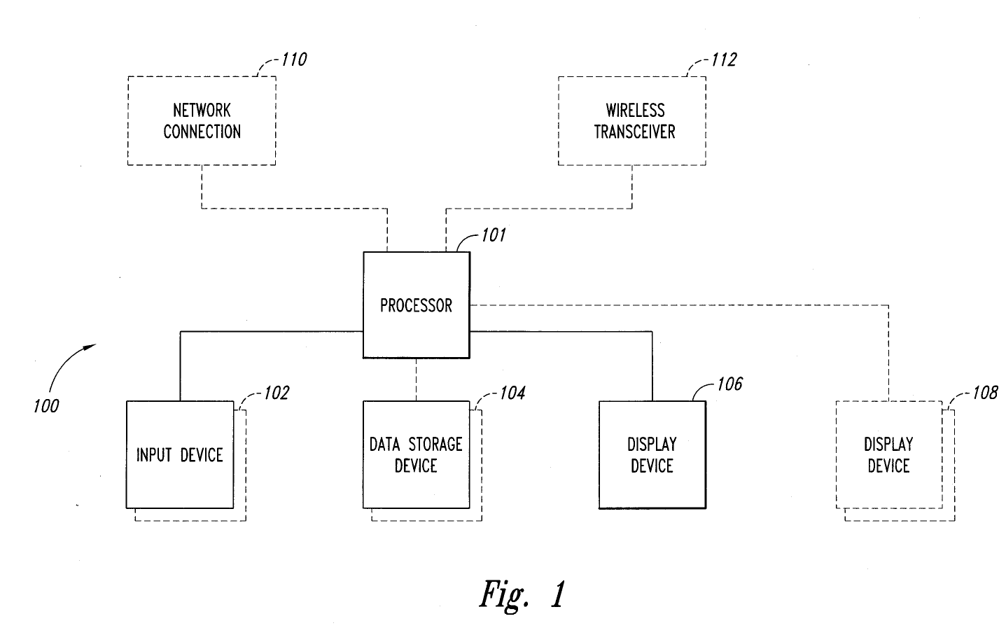

FIG. 1 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

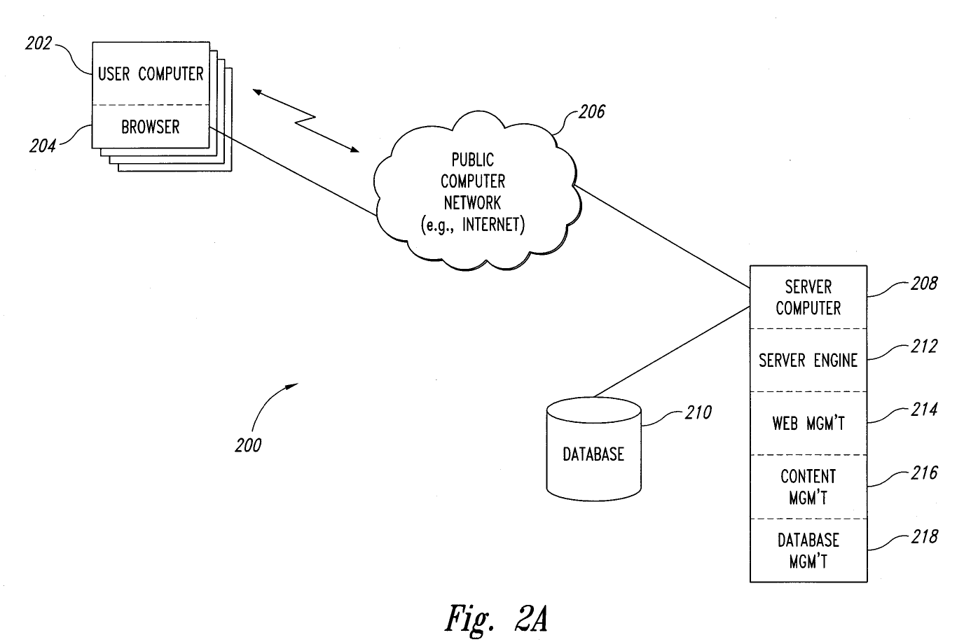

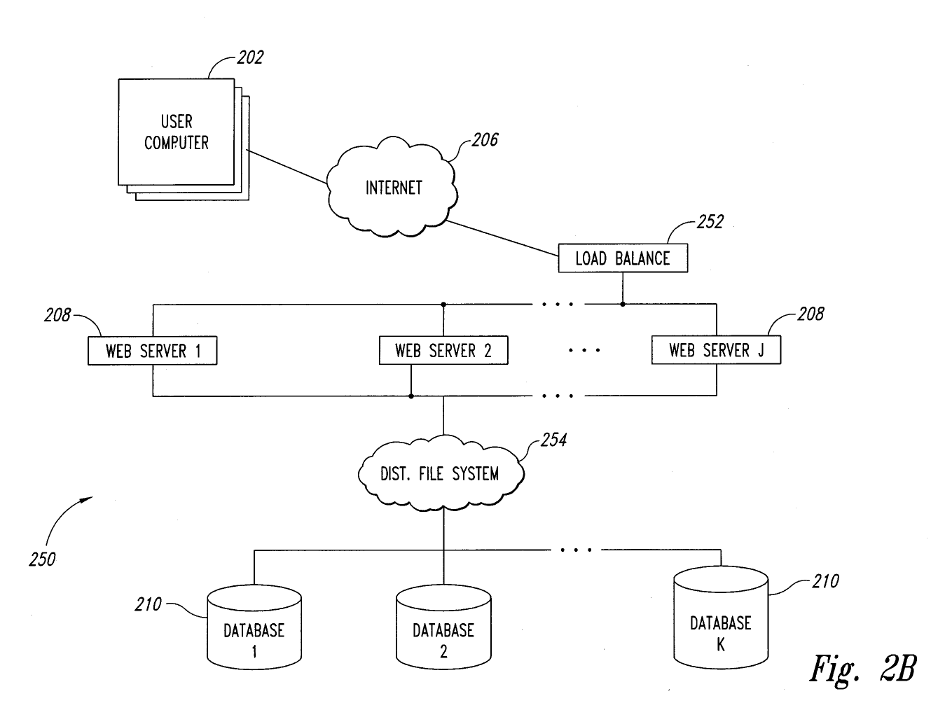

Aspects of the invention may be practiced in a variety of other computing environments. For example, referring to FIG. 2A, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

Referring to FIG. 2B, an alternative embodiment to the system 200 is shown as a system 250. The system 250 is substantially similar to the system 200, but includes more than one server computer (shown as server computers 1, 2, . . . J). A load balancing system 252 balances load on the several server computers. Load balancing is a technique well-known in the art for distributing the processing load between two or more computers, to thereby more efficiently process instructions and route data. Such a load balancer can distribute message traffic, particularly during peak traffic times.

A distributed file system 254 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

B. Embodiments of Methods and Systems for Opening, Funding, Managing, and/or Using Checking Accounts and other Financial and Non-Financial Accounts

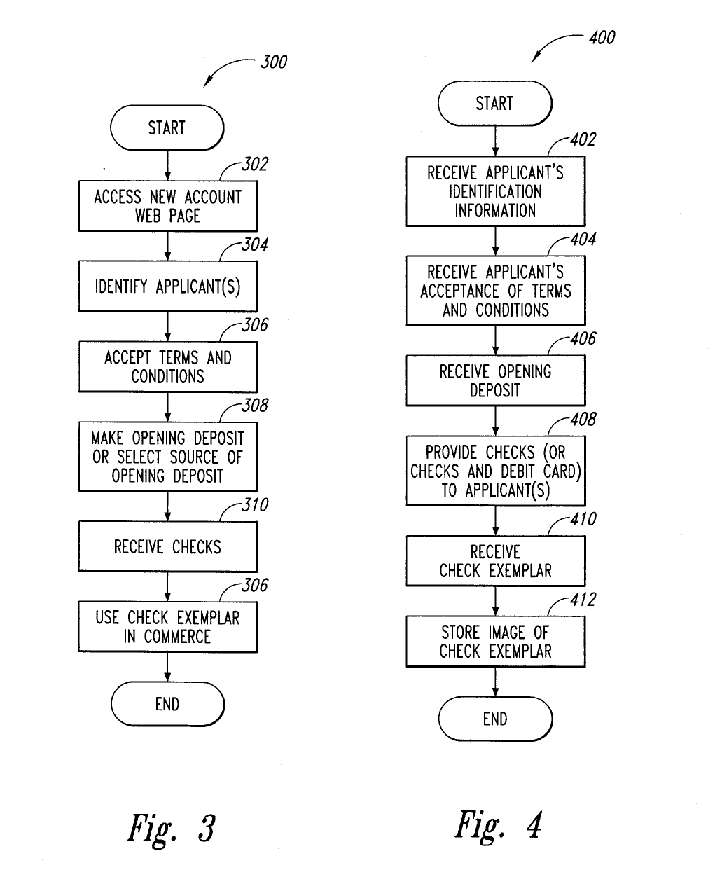

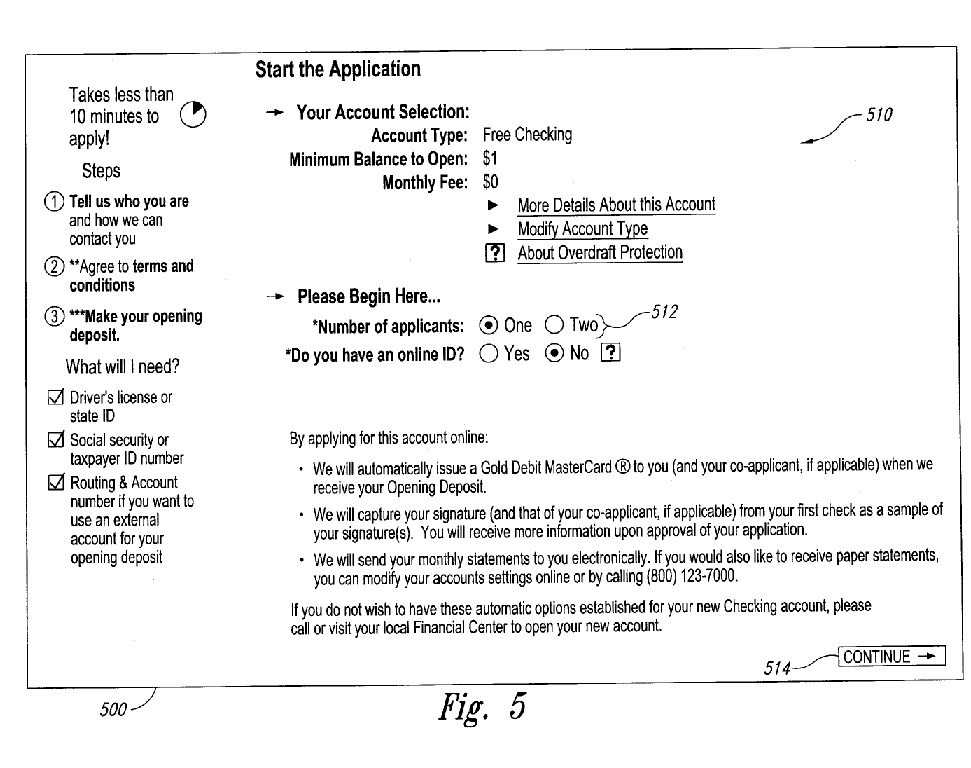

FIG. 3 is a flow diagram of a routine 300 for opening a financial account in accordance with one embodiment of the invention. In one aspect of this embodiment, the routine 300 can be at least partially performed by a person wishing to open a checking account with a user computer (e.g., the user computer 202 of FIG. 2A). In other embodiments, the routine 300 can be performed by other entities using other networked and non-networked devices to open other types of financial and non-financial accounts.

In block 202, the user accesses a new account web page from, e.g., a financial institution web site. In block 304, the user inputs personal information that identifies one or more applicants wishing to open the checking account. This information can include, for example, personal identification information such as a name, social security number, address, mother's maiden name, etc.

In block 306, the user can accept the terms and conditions of the checking account as displayed on an associated web page. In block 308, the user can make an opening deposit into the new checking account or select a source of funds for the opening deposit. As described in greater detail below, the deposit can be transferred from another financial account, from an in-person deposit, or from one or more other sources.

In block 310, after the bank has verified the applicant's personal information and source of funds, checks are sent to the user. In block 312, the user can begin using the checks in commerce. In one aspect of this embodiment, an image (that includes the account holder's signature or the account holders' signatures) from at least one of the checks used in commerce is retained by the bank for future reference in the event that signature verification and/or authentication is needed by the bank or other financial institution at a later date. After block 312, the routine 300 ends.

One advantage of the method described above for opening a new checking account is that the user does not have to print, fill out, and sign one or more paper documents and submit them to the bank to open the new account. Instead, all of the necessary actions on the part of the applicant can be performed on-line. Once the applicant has performed all the necessary on-line steps, and the requisite information has been verified by the bank, checks are sent to the applicant who can then begin using the checks immediately. As explained above, an image of at least one of the checks will be imaged and/or retained by the bank as the “exemplar” for future reference if needed. The foregoing method of the present invention can significantly reduce the effort the applicant has to expend to open a new account. Accordingly, use of this system can encourage people who would otherwise be deterred to open new accounts.

In one embodiment of the method described above, the account holder (or account holders) can receive a box of checks containing a special check, such as a first check, that includes one or more signature lines or similar regions in which the account holder or holders can sign. Upon receipt of this check, the bank can capture an image of the check so that it will have a record of the account holder's (or account holders') signature (or signatures) for future reference if needed. In another embodiment, the account holder (or account holders) can receive a box of checks that appear at least generally similar in structure and function to standard personal checks. In this embodiment, the bank can capture an image of the first check (or any other check) so that it will have a record of the first account holder's signature. Subsequent checks can then be scanned when submitted for payment, and if a different signature is recognized (e.g., the signature of a second account holder), then a second image can be recorded at that time so that the bank will have a complete record of both the first and second account holders' signatures. This second embodiment avoids the need to submit a check (e.g., a first check exemplar) with both account holders' signatures on it.

FIG. 4 is a flow diagram of a routine 400 for opening a new financial account for an applicant in accordance with an embodiment of the invention. In one aspect of this embodiment, the routine 400 can be performed by a bank or other financial institution in response to receiving a new-account application for a checking account or other account from an applicant. In block 402, the routine receives identification information for the new-account applicant. In block 404, the routine receives the applicant's acceptance of terms and conditions associated with the account. In block 406, the routine receives an opening deposit to fund the account.

On block 408, after the bank or other financial institution has verified the applicant's personal information and source of funds, the routine provides checks to the applicant. In one aspect of this embodiment, the checks can be at least generally similar in structure and function to conventional checks used with conventional checking accounts. In block 410, the routine receives one of the checks that the applicant has used in commerce. In this embodiment, this check can be identified as an “exemplar.” An image of this check can be made by the financial institution upon receipt, and the image can be stored for later retrieval and/or reference if needed to verify the account holder's signature. Such an event could occur, for example, if the bank wants to confirm the authenticity of a possibly-forged signature. Even though this check will be used as a type of “signature card” that contains an exemplar of the account holder's signature, it can still be used in commerce as a typical check. As explained above, using one of the checks as the signature exemplar alleviates the need for a separate signature card or other document to be provided by the applicant to serve this purpose. In block 412, the routine stores an image of the check exemplar in a database or other suitable storage medium. After block 412, the routine ends.

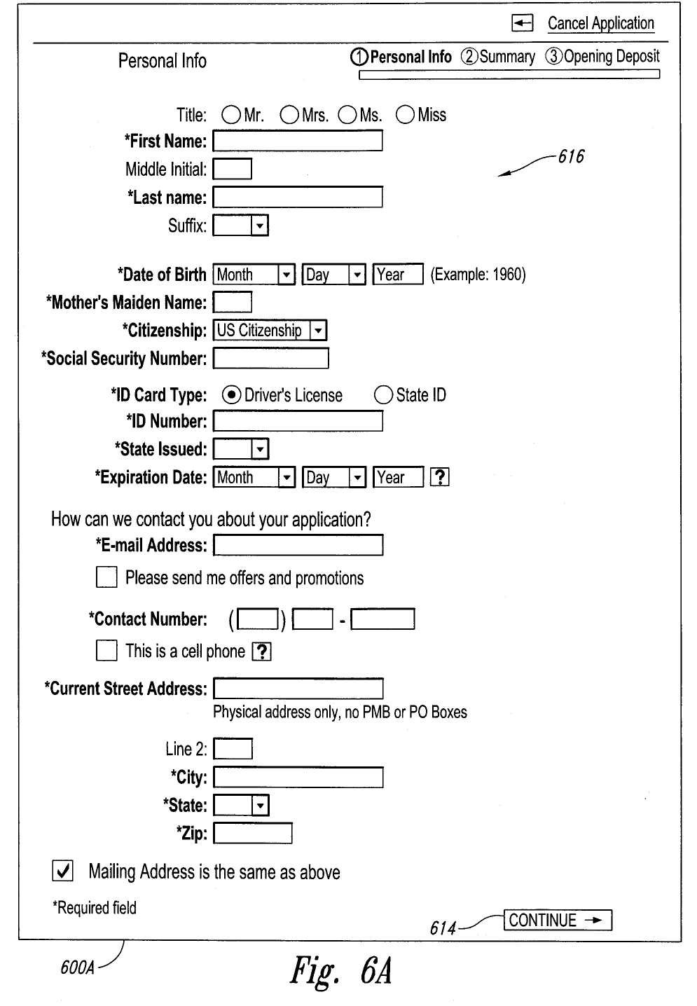

FIG. 5 is a schematic diagram of a screen display 500 configured in accordance with an embodiment of the invention. In one aspect of this embodiment, the screen display 500 can be presented to a user wishing to open a new account, such as a new checking account, with a financial institution. The screen display 500 includes a plurality of data entry fields and/or other portions whereby the user can enter information about himself or herself and/or about the particular account he or she wishes to open. For example, the screen display 500 can include an account selection portion 510 that indicates the type of account (e.g., a free checking account), the minimum opening balance required, the monthly fee, and/or other information about the particular type of account selected by the user. The screen display 500 can also include a “number of applicants” portion 512 with which the user can select either one or two applicants for the account. After providing the foregoing information and/or selections, the user can select a continue button 514 to proceed to the next screen display.

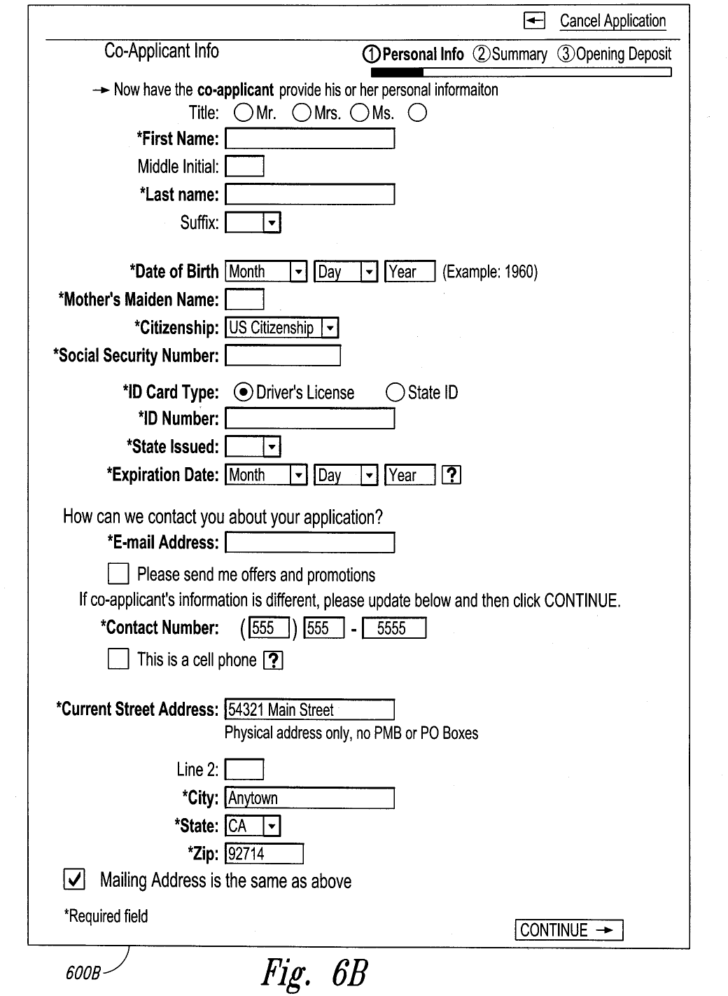

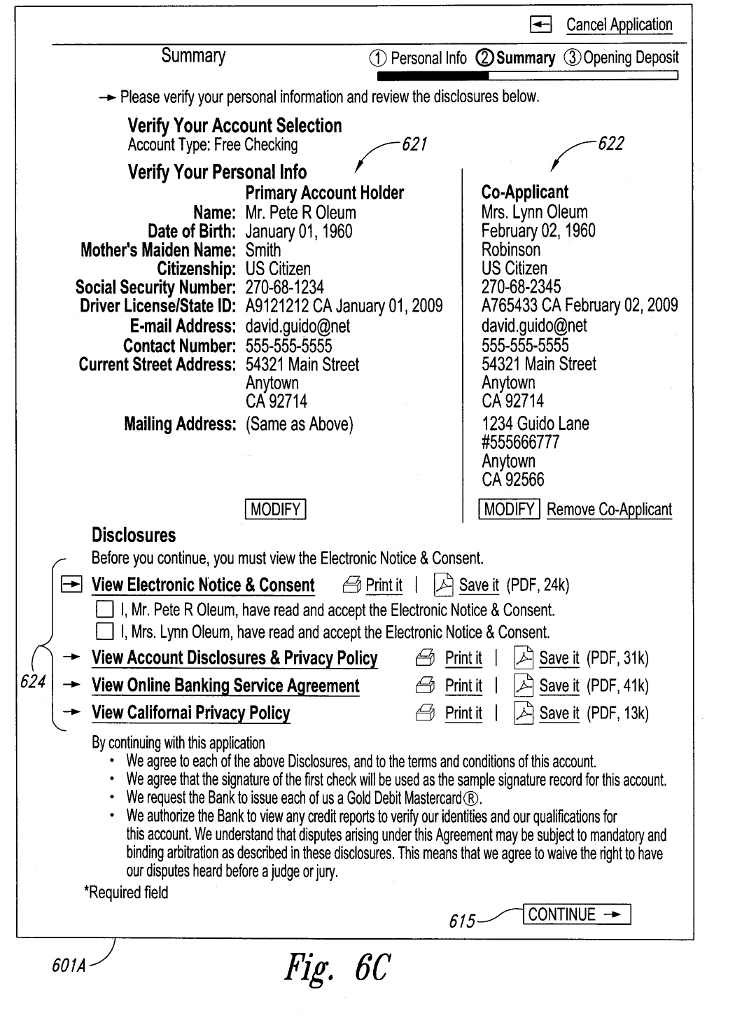

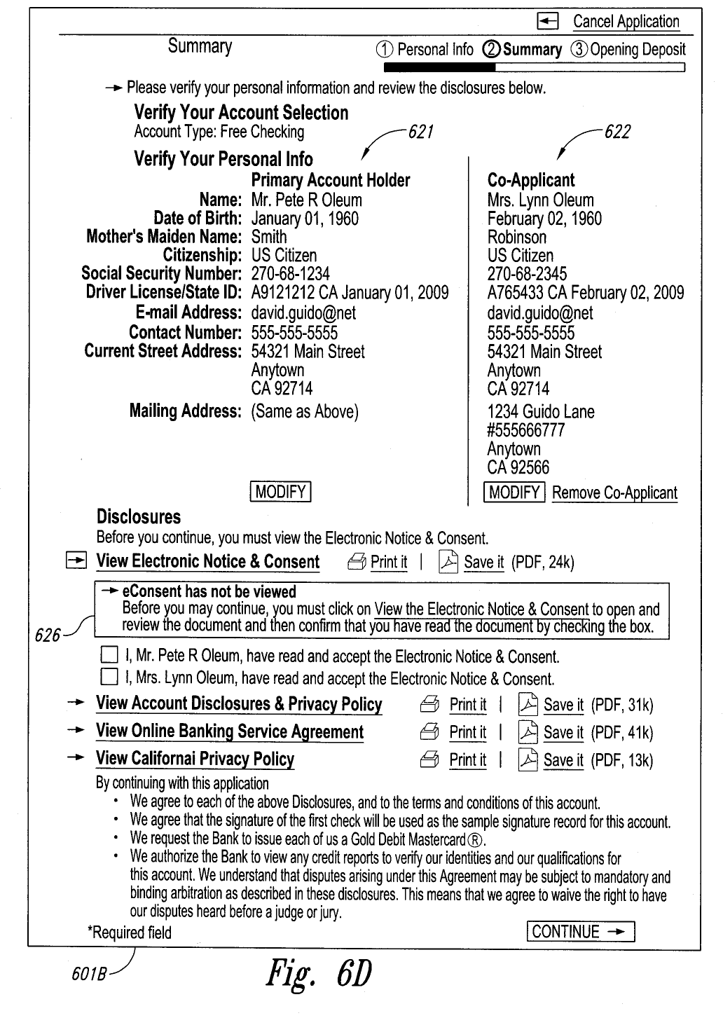

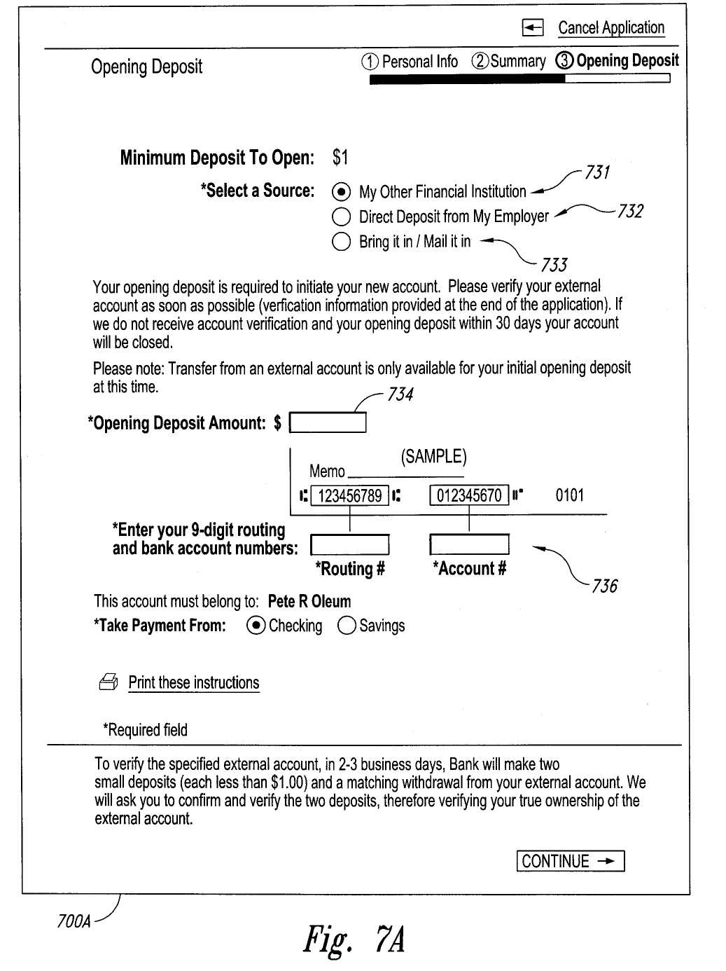

FIG. 6A is a schematic diagram of a screen display 600A configured in accordance with another embodiment of the invention. In one aspect of this embodiment, the screen display 600A can include a plurality of data entry fields configured to receive information about the account applicant or applicants. For example, the screen display 600 can include a name portion 616 in which the applicant can provide his or her name. The screen display 600A can also include other fields for obtaining applicant information such as a date-of-birth field, a mother's maiden name field, a social security number field, a driver's license field, and email address field, a current street address field, etc. After the user has input the required information, he or she can select a continue button 614 to proceed to the next screen display.

FIG. 6B is a schematic diagram of a screen display 600B in which a co-applicant of the checking account can input his or her personal information. Many of the fields in the screen display 600B are at least generally similar in structure and function to this screen display 600A described above with reference to FIG. 6A.

FIG. 6C is a schematic diagram of a screen display 601A in which the account applicant (and co-applicant) can verify the personal information they entered on the previous screen displays. For example, the screen display 601A includes an applicant portion 621 which provides all of the applicant's information for viewing and modifying (if necessary) by the applicant. The screen display 601A also includes a similar co-applicant portion 622 in which the information regarding the co-applicant can be confirmed and/or modified.

In another aspect of this embodiment, the screen display 601A also includes a disclosure portion 624. The disclosure portion 624 includes one or more links to consent and notice information that the applicants are required to read and consent to before the account can be opened. These documents include various disclosures and privacy policy statements. Once the applicants have confirmed the personal information and viewed and consented to the disclosures, the applicants can press a continue button 615 to proceed to the next screen display.

FIG. 6D is a schematic diagram of a screen display 601B that is at least generally similar to the screen display 601A described above. However, the screen display 601B includes a dialogue box that pops up if the applicant has not viewed and/or consented to the various disclosures and agreements illustrated in the disclosure portion 624 of FIG. 6C. Accordingly, the user may have to view and consent to these provisions before going forward with the account application.

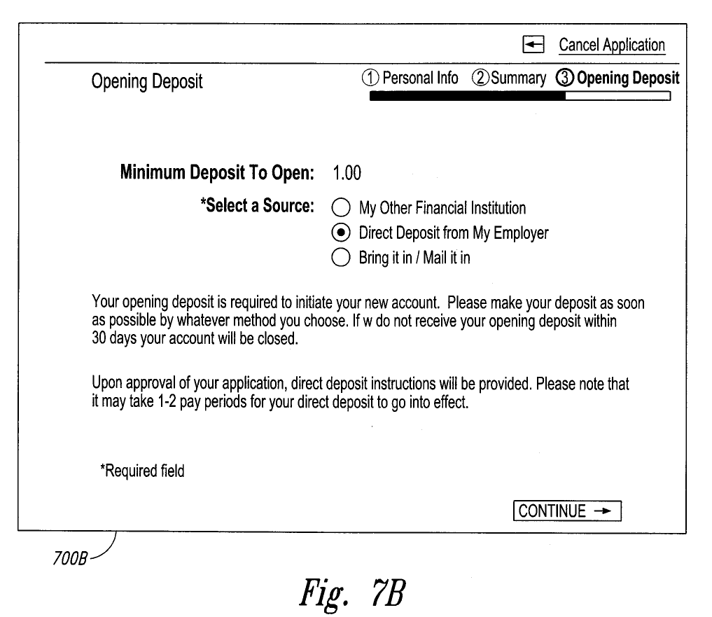

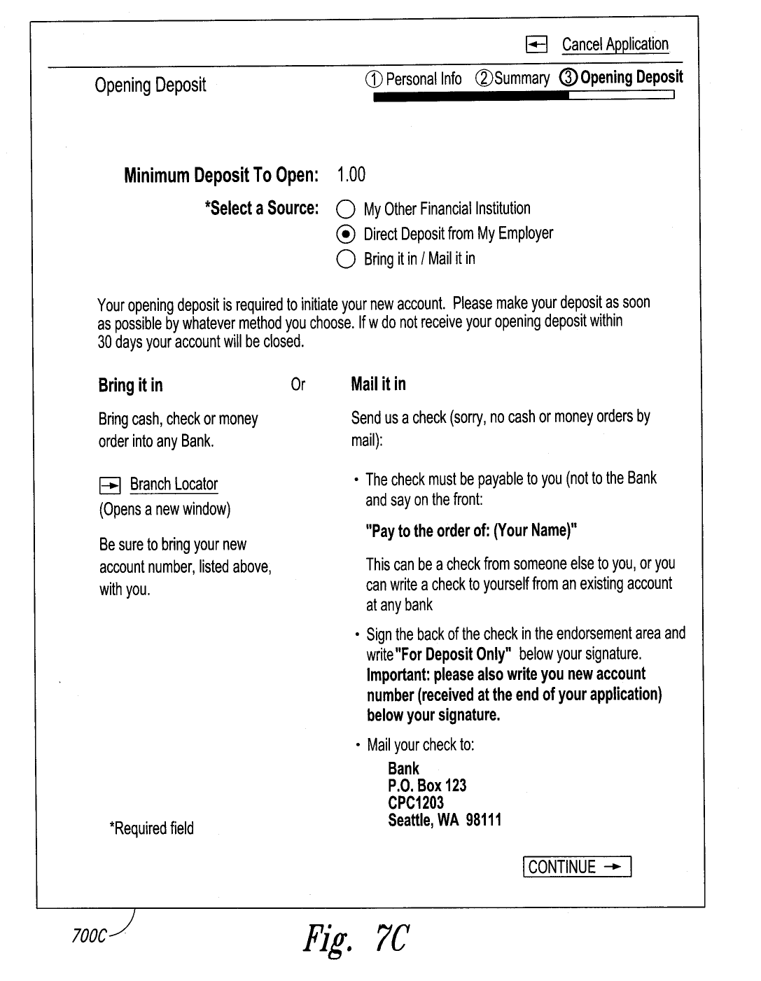

FIG. 7A is a schematic diagram of a screen display 700A in which the applicant can select a source of funds with which to fund the new account. In this regard, the screen display 700A includes a plurality of source options from which the applicant can choose. In this regard, the screen display 700A includes an account transfer field 731, a direct deposit field 732, and a bring in/mail in field 733. If the user wishes to fund the account by a transfer from another financial institution, the user can select the transfer option in field 731. Next, the user can input the amount of money he or she wishes to open the account with in an amount field 734. Further, the screen display 700A can include routing number and account number fields 736 in which the user can provide a corresponding routing number and account number for the transfer.

FIG. 7B is a schematic diagram of a screen display 700B that provides the user with information if the user elects to have the opening deposit for the new account deposited directly from an employer (e.g., as part of his or her payroll). Accordingly, the screen display 700B can include instructions informing the user how to set up the direct deposit. Similarly, FIG. 7C illustrates a screen display 700C that provides the user with information on how to either bring in the opening deposit or mail in the opening deposit to a selected branch of the financial institution.

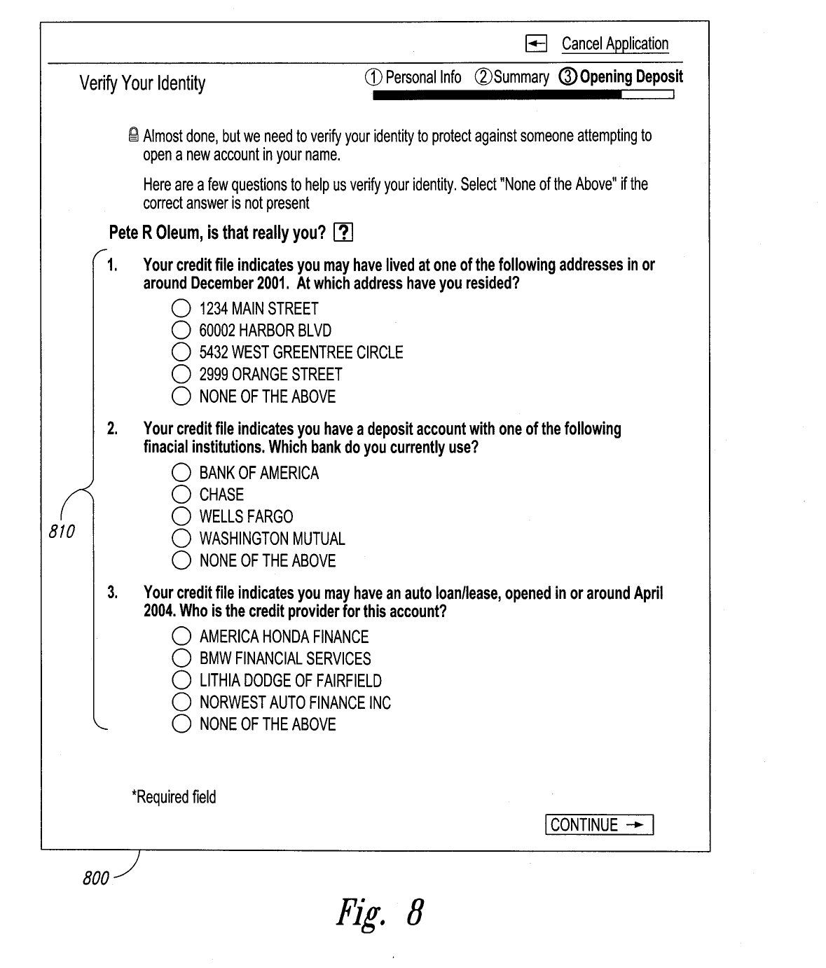

FIG. 8 is a schematic diagram of a screen display 800 that can be used to verify the identity of the account applicant in accordance with one embodiment of the invention. This screen display can be presented to the applicant after his or her application has been approved to ensure that the person actually setting up the account is in fact the named account holder. Accordingly, the screen display 800 can include one or more questions 810 that, presumably, only a person having the correct identity could answer correctly. Such questions can include questions relating to prior addresses, other financial accounts, etc.

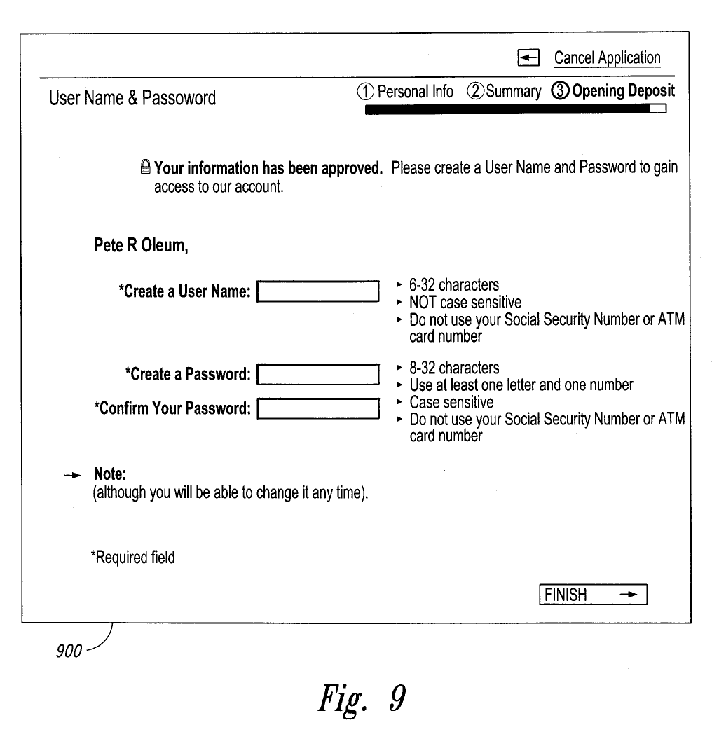

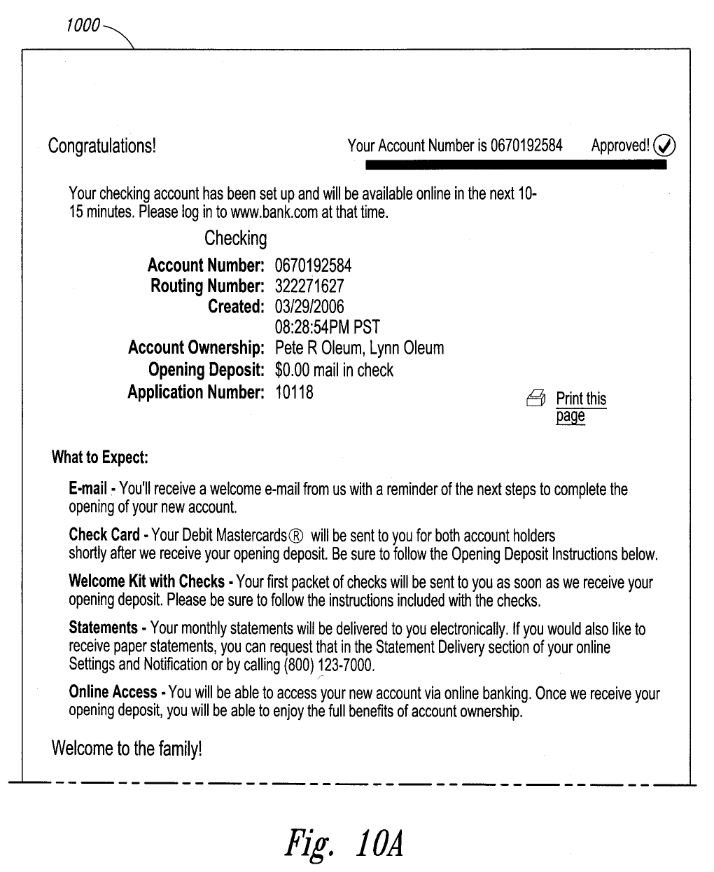

After the applicant's identity has been verified using, e.g., the screen display 800, the applicant can create a user name, password, etc., using a screen display 900 illustrated in FIG. 9. After the user name and password has been established, the applicant can use them to access his or her account information on-line.

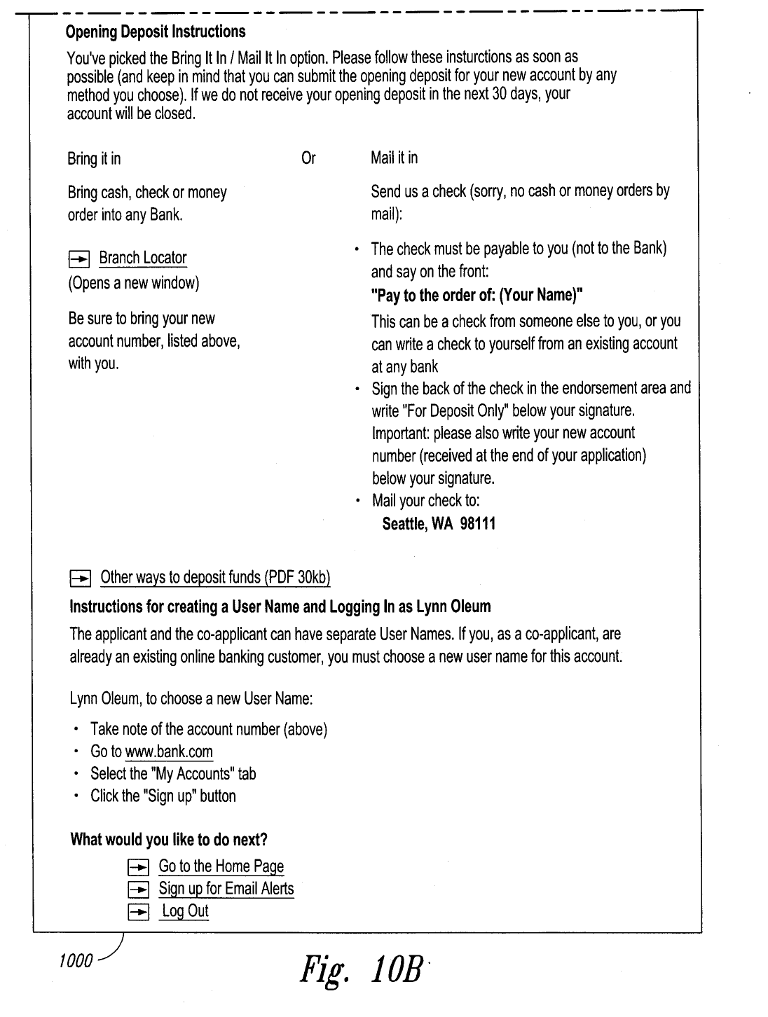

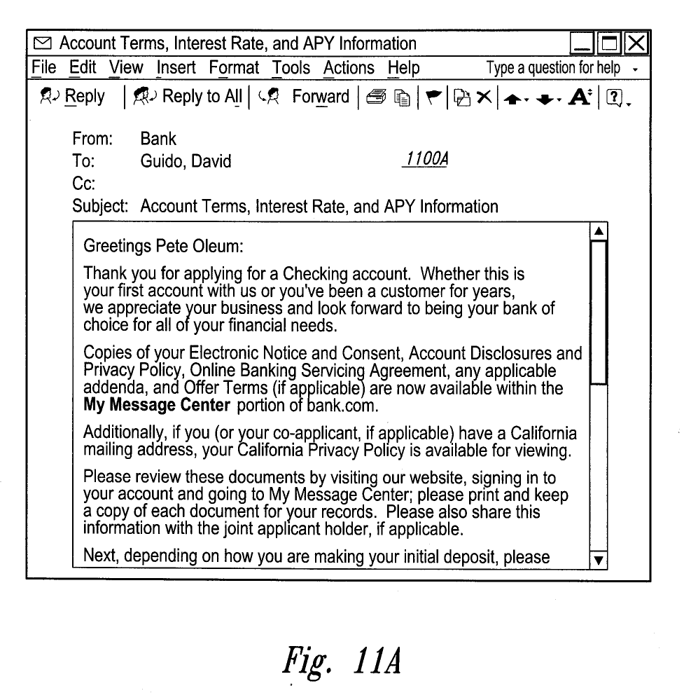

FIGS. 10A and 10B illustrate a screen display 1000 that indicates the applicant has been approved for the new account and explains next steps to the applicant. For example, in one embodiment, the applicant can expect to receive an email welcoming him or her to the account and providing him or her with next steps to complete opening of the new (e.g., checking) account. The screen display 1000 can also include text informing the applicant that he or she will be receiving a check card, a welcome kit with checks, statements, and/or other information or things.

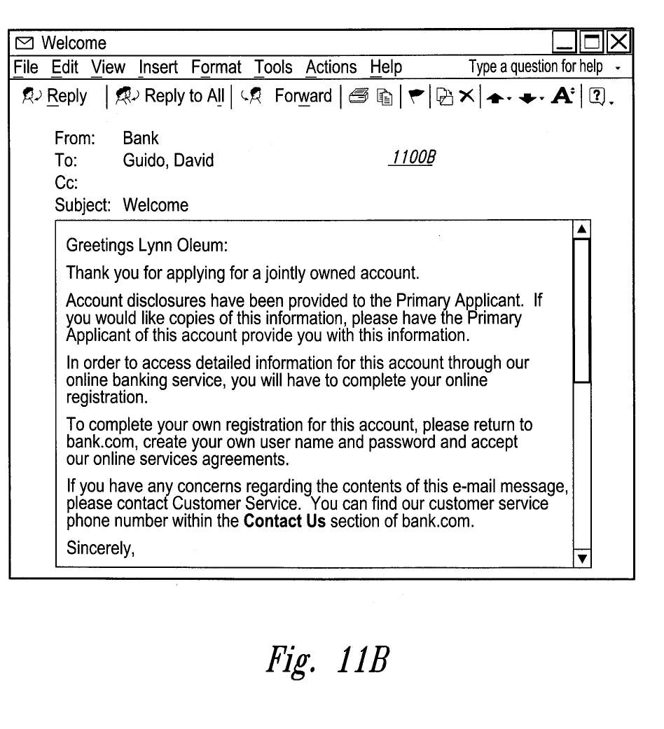

FIG. 11A is a schematic diagram of a screen display 1100A representing a welcoming email that can be sent to the new account applicant in accordance with one embodiment of the invention. The email can include various information about next steps, including some of the information conveyed on the screen display 1000 described above with reference to FIG. 10. Screen display 1100B illustrated in FIG. 11B is similar to the screen display 1100A illustrated in FIG. 11A, except that this email is for the joint owner of the new account.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments. Any patents, applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A computer-implemented method for providing a financial account to a user, the method comprising:
receiving a request from the user to open a financial account from which the user can withdraw funds;
in response to receiving the request from the user, providing a plurality of unused checks to the user;
receiving a first check from the plurality of checks, wherein the first check has been used in commerce by the user, and wherein the first check includes a first signature of the user;
storing an image of the first signature from the first check;
receiving a second check from the plurality of checks, wherein the second check has been used in commerce by the user, and wherein the second check includes a second signature of the user; and
comparing the second signature on the second check to the image of the first signature to authenticate the second signature.

2. The computer-implemented method of claim 1, further comprising cashing the second check when the comparison indicates the second signature is authentic.

3. The computer-implemented method of claim 1, further comprising satisfying the second check when the comparison indicates the second signature is authentic.

4. The computer-implemented method of claim 1 wherein the user is a first user, and wherein the method further comprises:
receiving a third check from a second user, wherein the third check includes a third signature;
comparing the third signature on the third check to the image of the first signature to authenticate the third signature; and
rejecting the third check when the comparison indicates the third signature is not authentic.

5. The computer-implemented method of claim 1 wherein the user is a first user and the image of the first signature is a first image, and wherein the method further comprises:
receiving a third check from the plurality of checks, wherein the third check has been used in commerce by a second user, and wherein the third check includes a third signature of the second user;
storing a second image of the third signature from the third check;
receiving a fourth check from the plurality of checks, wherein the fourth check has been used in commerce by the second user, and wherein the fourth check includes a fourth signature of the second user; and
comparing the fourth signature on the fourth check to the second image of the third signature to authenticate the fourth signature.

6. The computer-implemented method of claim 1 wherein the user is a first user, wherein the first check includes a third signature of a second user, wherein storing an image of the first signature includes storing an image of the first and third signatures from the first check, and wherein the method further comprises:
receiving a third check from the plurality of checks, wherein the third check has been used in commerce by the second user, and wherein the third check includes a fourth signature of the second user; and
comparing the fourth signature on the third check to the image of the third signature to authenticate the fourth signature.

7. The computer-implemented method of claim 1, further comprising:
receiving a third check from the plurality of checks, wherein the third check has been used in commerce by the user, and wherein the third check includes a third signature of the user; and
satisfying the third check before receiving the first and second checks from the plurality of checks.

8. The computer-implemented method of claim 1, further comprising:
receiving multiple checks from the plurality of checks, wherein each of the multiple checks has been used in commerce by the user, and wherein each of the multiple checks includes a signature of the user; and
satisfying the multiple checks before receiving the first and second checks from the plurality of checks.

9. The computer-implemented method of claim 1 wherein providing a plurality of unused checks to the user includes providing the first and second checks to the user, and wherein the first check differs from at least the second check in that the first check includes indicia indicating it will be used as an exemplar of the user's signature.

10. The computer-implemented method of claim 1 wherein receiving a request from the user to open a financial account includes receiving an electronic request from a remote computer via a computer network.

11. The computer-implemented method of claim 1 wherein receiving a request from the user to open a financial account includes receiving an electronic request from a remote computer located in a residence of the user, and wherein providing a plurality of unused checks to the user includes sending the unused checks to the residence of the user in response to receiving the electronic request.

12. A method for obtaining an exemplar of a signature for use in association with a financial account, the method comprising:
providing a series of computer-implemented display pages to a remote computer;
receiving, via the display pages, a request from a user to open a financial account;
at least partially in response to receiving the request from the user, opening a financial account for the user;
receiving a written request for funds to be drawn from the financial account, wherein the written request includes a signature of the user;
providing the funds in response to receiving the written request; and
storing an image of the signature from the written request as a signature exemplar for subsequent use in authenticating the signature of the user.

13. The method of claim 12 wherein receiving a written request includes receiving a bank check.

14. The method of claim 12 wherein receiving a written request includes receiving an electronic request.

15. The method of claim 12 wherein receiving, via the display pages, a request from a user to open a financial account includes receiving an opening deposit with which to fund the account.

16. The method of claim 12 wherein receiving, via the display pages, a request from a user to open a financial account includes receiving an opening deposit via an electronic funds transfer.

17. A system for opening a checking account, the system comprising:
means for receiving a request from a user to open a checking account;
means for opening a checking account for the user in response to receiving the request;
means for receiving a first check that includes a first signature of the user and specifies a first amount of funds;
means for transferring the amount funds out of the checking account in response to receiving the first check;
means for storing an image of the first signature of the user from the first check;
means for receiving a second check that includes a second signature of the user and specifies a second amount of funds; and
means for comparing the second signature on the second check to the image of the first signature to authenticate the second signature.

18. The system of claim 17, further comprising means for transferring the second amount funds out of the checking account when the comparison of the second signature to the image of the first signature indicates the second signature is authentic.

19. The system of claim 17 wherein the means receiving a request from the user to open a financial account include means for receiving an electronic request from a remote computer via a computer network.

20. The system of claim 17 wherein the means for opening a checking account for the user include means for automatically sending a plurality of unused checks to a residence of the user.
